(19) United States
(12) Patent Application Publication
(10) Pub. No.: US 2022/0024445 A1
(43) Pub. Date: Jan. 27, 2022

(54) VEHICLE JUMP DETECTION AND CONTROL SYSTEM

(71) Applicants: Jeremy J Anker, Lake Orion, MI (US); John O Lagalski, Grand Blanc, MI (US); Richard A Myers, Waterford, MI (US); Kyle Schumaker, Royal Oak, MI (US); Drushan Mavalankar, Rochester Hills, MI (US); Ethan E Bayer, Lake Orion, MI (US); Dustin M Kolodge, St. Clair Shores, MI (US)

(72) Inventors: Jeremy J Anker, Lake Orion, MI (US); John O Lagalski, Grand Blanc, MI (US); Richard A Myers, Waterford, MI (US); Kyle Schumaker, Royal Oak, MI (US); Drushan Mavalankar, Rochester Hills, MI (US); Ethan E Bayer, Lake Orion, MI (US); Dustin M Kolodge, St. Clair Shores, MI (US)

(21) Appl. No.: 16/937,169

(22) Filed: Jul. 23, 2020

(51) Int. Cl. B60W 30/02; B60W 40/10; B60W 10/06; B60W 10/10; B60W 10/02; B60W 10/22

(52) U.S. Cl. CPC B60W 30/02; B60W 40/10; B60W 10/06; B60W 2520/00; B60W 10/02; B60W 10/22; B60W 10/10

(57) ABSTRACT

A vehicle jump detection method and system for a vehicle includes an electronic control module (ECM), at least one ride height sensor (RHS) in signal communication with the ECM and configured to measure a vertical wheel travel distance from a predetermined point on the vehicle, at least one accelerometer in signal communication with the ECM and configured to measure a vertical acceleration of the vehicle frame, and a vehicle speed sensor in signal communication with the ECM. The ECM is configured to independently determine, based on one or more signals from the at least one RHS, the at least one accelerometer, and the vehicle speed sensor, if (i) wheels of a front axle are in the air, (ii) wheels of a rear axle are in the air, and (iii) if the wheels of both the front and rear axles are in the air.

### FIELD

The present application relates generally to motor vehicles and, more particularly, to a motor vehicle jump detection and control system.

### BACKGROUND

While driving a motor vehicle, the driver and/or vehicle may perform a jump where the vehicle's wheels leave the driving surface. In some cases, if the speed of the vehicle's wheels change while the vehicle is in the air (e.g., the driver engages the accelerator pedal), upon landing the vehicle can potentially experience large shock loads in the driveline, which can potentially damage driveline components like the axles, the transfer case, and the half shafts. While some conventional systems work well for their intended purpose to prevent such shock loads, there remains a desire for improvement in the relevant art.

### SUMMARY

According to one example aspect of the invention, a vehicle jump detection system for a vehicle having a front axle with front wheels and a rear axle with rear wheels is provided. In one example configuration, the system includes an electronic control module (ECM), at least one ride height sensor (RHS) in signal communication with the ECM and configured to measure a vertical wheel travel distance from a predetermined point on the vehicle, at least one accelerometer in signal communication with the ECM and configured to measure a vertical acceleration of the vehicle frame, and a vehicle speed sensor in signal communication with the ECM. The ECM is programmed to independently determine, based on one or more signals from the at least one RHS, the at least one accelerometer, and the vehicle speed sensor, if (i) the wheels of the front axle are in the air, (ii) the wheels of the rear axle are in the air, and (iii) if the wheels of both the front and rear axles are in the air.

In addition to the foregoing, the described system may include one or more of the following features: wherein when the ECM determines (iii) both the front and rear axles are in the air, a powertrain control module (PCM) is programmed to limit engine torque to prevent acceleration of wheels of the vehicle to higher than a speed measured at the time ECM determines both the front and rear axles are in the air; a transmission control module (TCM) in signal communication with the ECM; and wherein when the ECM determines (i) the front axle is in the air, the TCM is programmed to hold a current gear of a transmission of the vehicle unless over-rev protection is required.

In addition to the foregoing, the described system may include one or more of the following features: wherein when the ECM determines (ii) the rear axle is in the air, the TCM is programmed to hold a current gear of a transmission of the vehicle unless over-rev protection is required; and wherein when the ECM determines (iii) both the front and rear axles are in the air, the TCM is programmed to hold a current gear of a transmission of the vehicle unless over-rev protection is required.

In addition to the foregoing, the described system may include one or more of the following features: a drivetrain control module (DTCM) in signal communication with the ECM; and wherein when the ECM determines (iii) both the front and rear axles are in the air, the DTCM is programmed to limit front axle clutch torque application to facilitate preventing torque spikes through the driveline induced by landing loads.

In addition to the foregoing, the described system may include one or more of the following features: wherein the at least one RHS comprises a front-right RHS configured to measure a vertical wheel travel distance of a front-right wheel of the vehicle, a front-left RHS configured to measure a vertical wheel travel distance of a front-left wheel of the vehicle, a rear-right RHS configured to measure a vertical wheel travel distance of a rear-right wheel of the vehicle, and a rear-left RHS configured to measure a vertical wheel travel distance of a rear-left wheel of the vehicle, wherein the one or more signals from the at least one RHS, the at least one accelerometer, and the vehicle speed sensor includes signals indicative of the vertical wheel travel distance measured by the front-right RHS, the front-left RHS, the rear-right RHS, and the rear-left RHS.

In addition to the foregoing, the described system may include one or more of the following features: wherein the at least one accelerometer comprises a front-right accelerometer configured to measure a vertical acceleration of a front-right portion of the vehicle, a front-left accelerometer configured to measure a vertical acceleration of a front-left portion of the vehicle, and a rear-center accelerometer configured to measure a vertical acceleration of a rear-center portion of the vehicle, wherein the one or more signals from the at least one RHS, the at least one accelerometer, and the vehicle speed sensor includes signals indicative of the vertical acceleration measured by the front-right accelerometer, the front-left accelerometer, and the rear-center accelerometer.

In addition to the foregoing, the described system may include one or more of the following features: wherein the vehicle speed sensor is configured to measure a speed of the vehicle, wherein the one or more signals from the at least one RHS, the at least one accelerometer, and the vehicle speed sensor includes signals indicative of the measured vehicle speed, and wherein the measured vehicle speed must exceed a predetermined vehicle speed threshold for the ECM to determine (i) the wheels of the front axle are in the air, (ii) the wheels of the rear axle are in the air, and (iii) if the wheels of both the front and rear axles are in the air; and an active damping control module (ADCM) configured to manage stiffness of dampers of the vehicle, wherein the ADCM receives the one or more signals from the at least one RHS and the at least one accelerometer and communicates the one or more signals to the ECM.

According to one example aspect of the invention, a method of jump detection and control for a vehicle having a front axle with front wheels, a rear axle with rear wheels, and an electronic control module (ECM) in signal communication with at least one ride height sensor (RHS), at least one accelerometer, and a vehicle speed sensor is provided. In one example configuration, the method includes determining with the ECM, based on one or more signals from the at least one RHS, the at least one accelerometer, and the vehicle speed sensor, if (i) the wheels of the front axle are in the air, determining with the ECM, based on the one or more signals from the at least one RHS, the at least one accelerometer, and the vehicle speed sensor, if (ii) the wheels of the rear axle are in the air, and determining with the ECM, the one or more signals from the at least one RHS, the at least one accelerometer, and the vehicle speed sensor, if (iii) the wheels of both the front and rear axles are in the air. When (i), (ii), and/or (iii) is determined, the method includes sending a signal from the ECM to automatically implement vehicle powertrain control compensation to improve vehicle stability, driveability, and durability.

In addition to the foregoing, the described method may include one or more of the following features: wherein automatically implementing vehicle powertrain control compensation comprises (a) restricting propulsion acceleration to prevent wheel speeds from increasing, and (b) preventing gear shifts of a transmission of the vehicle; and wherein the one or more signals from the at least one RHS, the at least one accelerometer, and the vehicle speed sensor includes a signal indicative of a vertical wheel travel distance measured by the at least one ride height sensor (RHS).

In addition to the foregoing, the described method may include one or more of the following features: wherein the one or more signals from the at least one RHS, the at least one accelerometer, and the vehicle speed sensor includes a signal indicative of a measured vertical acceleration measured by the at least one accelerometer; and wherein the one or more signals from the at least one RHS, the at least one accelerometer, and the vehicle speed sensor includes a signal indicative of a vehicle speed measured by the vehicle speed sensor.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a top view of an example powertrain for a four-wheel drive vehicle in accordance with the principles of the present disclosure;

FIG. 2 is a schematic illustration of an example jump detection system that may be utilized with the vehicle shown in FIG. 1, in accordance with the principles of the present disclosure;

FIG. 3 is a graph of an example learn strategy of the jump detection system shown in FIG. 2, in accordance with the principles of the present disclosure;

FIG. 4 is a graph illustrating an example determination and declaration of a vehicle jump condition of the jump detection system of FIG. 2, in accordance with the principles of the present disclosure;

FIG. 5 is a state diagram illustrating example states of the jump detection system shown in FIG. 2, in accordance with the principles of the present disclosure; and

FIG. 6 is a table illustrating example operations of the jump detection system of FIG. 2, in accordance with the principles of the present disclosure.

### DESCRIPTION

The present application is directed to systems and methods for detecting and signaling when an axle's wheels have lost contact with the driving surface (i.e., the vehicle has “jumped”). The signal(s) are then utilized by other vehicle systems such as, for example, engine, transmission, and drivetrain control modules to automatically implement powertrain control compensation and thereby maintain vehicle stability, improve driveability, and limit shock to driveline components to improve durability.

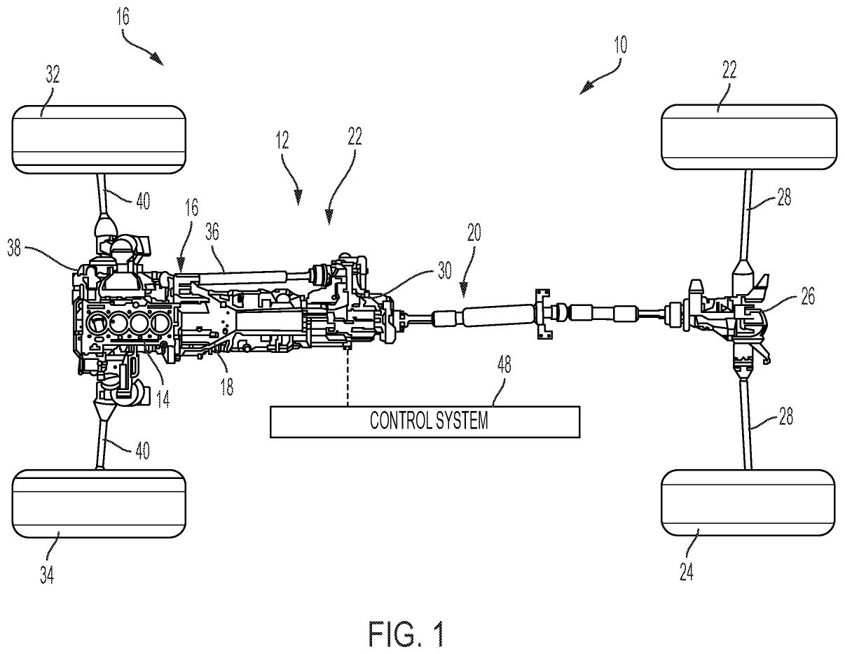

With initial reference to FIG. 1, a vehicle 10 in accordance with the principles of the present disclosure is illustrated. The vehicle 10 is shown only in part to highlight a powertrain system 12, which in the example embodiment, generally includes a source of power such as an internal combustion engine 14, a clutch or torque converter 16, and a transmission 18, which may be of either the manual or automatic type. Reciprocating motion of the engine 14 is converted into rotational motion via torque converter 16 and transmitted to a drive shaft 20 via the transmission 18. Rotational motion of the drive shaft 20 is transferred to rear wheels 22, 24 via a rear differential 26 and rear drive axles 28. A transfer case 30 is configured to transfer rotational motion to front wheels 32, 34 via a front drive shaft 36, front differential 38, and front drive axles 40. In the example embodiment, the vehicle 10 is a rear wheel drive vehicle operable for normally driving the rear wheels 22, 24 in a two-wheel drive mode. A torque transfer system utilizes transfer case 30 to further drive the front wheels 32, 34 in a four-wheel drive mode.

In the example embodiment, vehicle 10 further includes a control system 48 configured to control operation of the powertrain system 12 and various other operations of the vehicle 10. In the illustrated example, control system 48 generally includes a controller or electronic control module (ECM) 50, a powertrain control module 52, a transmission control module (TCM) 54, a drivetrain control module (DTCM) 56, and a controller or active damping control module (ADCM) 58, which is configured to manage stiffness of dampers (not shown) to facilitate preventing the vehicle from slamming on jounce bumpers upon landing from a jump. As described herein in more detail, the control system 48 is configured to determine if one or more vehicle axles and associated wheels have left the ground or jumped from the driving surface, and automatically implement powertrain control compensation in response thereto. As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

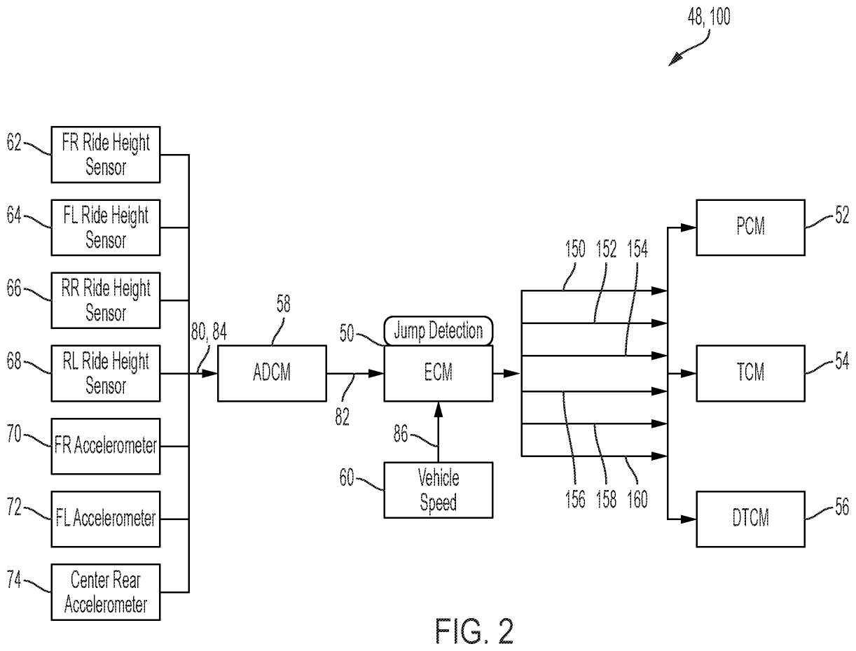

With additional reference to FIG. 2, in the example embodiment, control system 48 includes a jump detection system 100 that generally includes ECM 50 in signal communication with PCM 52, TCM 54, DTCM 56, and ADCM 58. ECM 50 is further in signal communication with a vehicle speed sensor 60, which is configured to selectively send a signal 86 to ECM 50 indicating a speed of vehicle 10. Moreover, ADCM 58 is in signal communication with a first or front-right ride height sensor (RHS) 62, a second or front-left RHS 64, a third or rear-right RHS 66, a fourth or rear-left RHS 68, a first or front-right accelerometer 70, a second or front-left accelerometer 72, and a third or center-rear accelerometer 74. It will be appreciated, however, that RHS sensors and accelerometers may be in direct or indirect signal communication with other controllers or modules such as ECM 50.

In the example embodiment, each ride height sensor is an electronic device configured to measure a wheel travel distance from a point on the chassis. In one example, vertical movement of the wheel detected through angular displacement of the sensor (e.g., −70° to 70°) is converted to a voltage signature (e.g., zero to five volts). Front-right RHS 62 is configured to be disposed on or near front wheel 32, front-left RHS 64 is configured to be disposed on or near front wheel 34, right-rear RHS 66 is configured to be disposed on or near rear wheel 22, and rear-left RHS 68 is configured to be disposed on or near rear wheel 24. As such, one RHS sensor is disposed on or proximate one wheel of vehicle 10 to determine a movement of the associated wheel and subsequently send a signal 80 indicative thereof to the ADCM 58, which subsequently sends a signal 82 that includes such measured data to ECM 50.

In the example embodiment, each accelerometer is an electronic device configured to measure vehicle acceleration and in particular, a vertical acceleration of the chassis (e.g., a g-force in the z-axis direction). In the example implementation, front-right accelerometer 70 is disposed on the frame near front wheel 32, front-left accelerometer 72 is disposed on the frame near front wheel 34, and center-rear accelerometer 74 is disposed generally on the frame between rear wheels 22, 24. However, it will be appreciated that any number of accelerometers and locations thereof may be utilized that enables control system 48 to function as described herein. As such, accelerometers are disposed on the vehicle 10 to determine a vertical acceleration of the vehicle and subsequently send a signal 84 indicative thereof to the ADCM 58, which measurements are subsequently included in signal 82 to ECM 50.

The jump detection system 100 is configured to detect if vehicle 10 has jumped or become airborne, and then subsequently adjust powertrain control to improve stability, driveability, and durability. To detect if vehicle 10 has jumped, ECM 50 is programmed to determine if the rear drive axle 28 (and thus rear wheels 22, 24), the front drive axle 40 (and thus front wheels 32, 34), or both axles 28, 40 have left the driving surface. To accomplish this determination, ECM 50 is first calibrated by learning RHS rebound voltages by reading the RHS voltage at each wheel with the suspension at full rebound or full extension (e.g., by putting the vehicle on a lift), to thereby establish a learned rebound RHS voltage. This may be done during manufacture and/or throughout the life of the vehicle. This facilitates the jump detection system compensating for and preventing effects from issues such as, for example, vehicle-to-vehicle variability, part-to-part variability of ride height sensors, ride height variability due to different springs and options, settling of spring, vehicle occupants, variable fuel levels, spring aging, and aftermarket modifications.

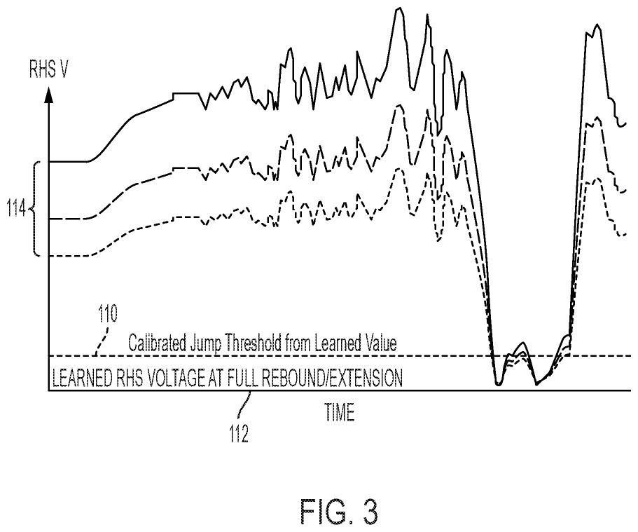

Once the baseline RHS values are learned, the ECM 50 is then programmed with a calibrated jump threshold, which is calibrated at a particular offset from the learned rebound RHS voltage, and with a calibrated land threshold, which is calibrated at a particular offset from the learned rebound RHS voltage. In one example, the calibrated land threshold has a greater voltage offset from the learned rebound RHS voltage than the calibrated jump threshold. This is to protect from prematurely declaring the land of an axle (the axle's wheels regain contact with the ground) due to dynamic oscillations at the rebound position induced during jumping scenarios. For example, as shown in FIG. 3, the calibrated jump threshold 110 (and calibrated land threshold) is offset from the learned rebound RHS voltage 112 and outside of the potential curb height vehicle-to-vehicle variability and variability over vehicle life 114. As such, the jump threshold 110 (and land threshold) will not be affected by vehicle-to-vehicle variability and will be consistent over the vehicle life.

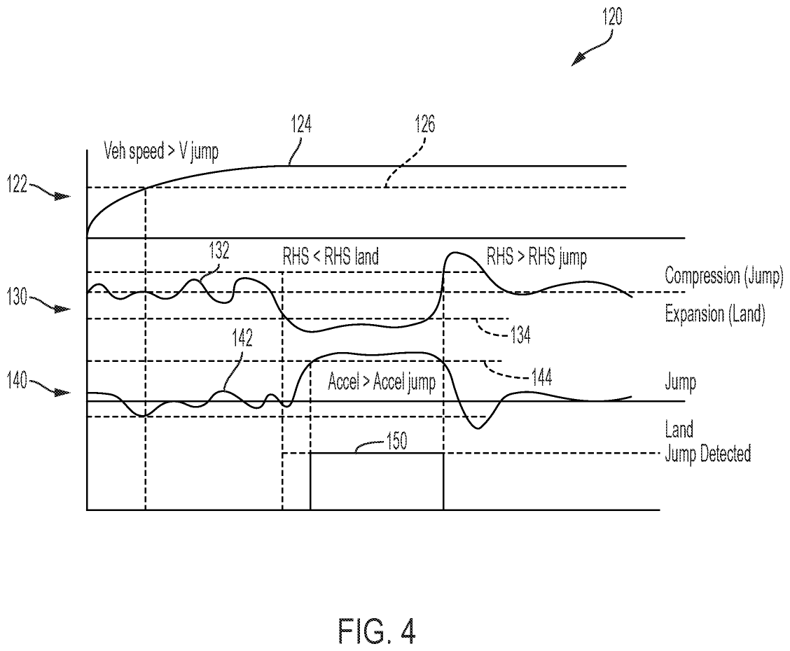

With additional reference to FIG. 4, an example graph 120 illustrates conditions for ECM 50 determining and declaring a vehicle jump condition for a single corner including one RHS and one accelerometer (which logic can be expanded to include four corners). In the example embodiment, in order to declare a vehicle jump condition, the ECM 50 must satisfy three conditions. The first condition 122 is met when a measured vehicle speed (line 124) exceeds a predetermined vehicle speed threshold (line 126), as determined by one or more signals 86 from vehicle speed sensor 60. The first condition insures, for example, that the vehicle is not merely in an off-road driving mode or rock crawling where one or more wheels may be out of contact with the driving surface, but the powertrain system 12 does not require vehicle jump adjustment.

The second condition 130 is met when a measured RHS voltage (line 132) is less than a predetermined vehicle RHS voltage threshold (line 134) (e.g., the calibrated jump threshold), as determined by one or more signals 80 from one or more of RHS sensors 62, 64, 66, 68. The third condition 140 is met when a measured acceleration (line 142) is greater than a predetermined acceleration threshold (line 144), as determined by one or more signals 84 from one or more of accelerometers 70, 72, 74. As illustrated, a jump (line 150) is detected for any period of time in which the three conditions are satisfied. Additionally, in some examples, ECM 50 may include a timer configured to measure jump time (time when the conditions are met) and perform a rationality check that inhibits the jump detection feature (or jump declaration) if the timer exceeds a predetermined time limit (e.g., 2.0 seconds).

In the example embodiment, ECM 50 is programmed to determine and make three different jump declarations, namely, (i) Front Axle in Air Jump Declaration, (ii) Rear Axle in Air Jump Declaration, and (iii) Both Axles in Air Jump Declaration.

In the example implementation, in order to make the (i) Front Axle in Air Jump Declaration, ECM 50 requires agreement of the front-right RHS 62, the front-left RHS 64, the front-right accelerometer 70, and the front-left accelerometer 72. That is, in addition to the measured vehicle speed 124 exceeding the predetermined vehicle speed threshold 126, the measurements at each of front-right RHS 62 and front-left RHS 64 must be less than the predetermined vehicle RHS voltage threshold 134. Similarly, the measurements at each of front-right accelerometer 70 and front-left accelerometer 72 must be greater than the predetermined acceleration threshold 144. Once the vehicle speed threshold is exceeded and the sensors 66, 68, 74 indicate front axle 40 is in the air, the ECM 50 makes a Front Axle in Air Jump Declaration and sends a signal 150 indicative thereof, as shown in FIG. 2.

In the example implementation, in order to make the (ii) Rear Axle in Air Jump Declaration, ECM 50 requires agreement of the rear-right RHS 66, the rear-left RHS 68, and the center-rear accelerometer 74. That is, in addition to the measured vehicle speed 124 exceeding the predetermined vehicle speed threshold 126, the measurements at each of rear-right RHS 66 and rear-left RHS 68 must be less than the predetermined vehicle RHS voltage threshold 134. Similarly, the measurements at center-rear accelerometer 74 must be greater than the predetermined acceleration threshold 144. Once the vehicle speed threshold is exceeded and the sensors 62, 64, 70, 72 indicate rear axle is in the air, the ECM 50 makes a Rear Axle Jump Declaration and sends a signal 152 indicative thereof, as shown in FIG. 2.

In the example implementation, in order to make the (iii) Both Axles in Air Jump Declaration, ECM requires agreement of the front-right RHS 62, the front-left RHS 64, the rear-right RHS 66, the rear-left RHS 68, the front-right accelerometer 70, the front-left accelerometer 72, and the center-rear accelerometer 74. That is, in addition to the measured vehicle speed 124 exceeding the predetermined vehicle speed threshold 126, the measurements at each of front-right RHS 62, front-left RHS 64, rear-right RHS 66, and rear-left RHS 68 must be less than the predetermined vehicle RHS voltage threshold 134. Similarly, the measurements at each of front-right accelerometer 70, front-left accelerometer 72, and center-rear accelerometer 74 must be greater than the predetermined acceleration threshold 144. Once the vehicle speed threshold is exceeded and the sensors 62, 64, 66, 68, 70, 72, 74 indicate both axles are in the air, the ECM 50 makes a Both Axles in Air Jump Declaration and sends a signal 154 indicative thereof, as shown in FIG. 2.

As shown in FIG. 2, and as described herein, ECM 50 is programmed to determine and declare one or more Jump Declarations based on one or more signals from ADCM 58 and vehicle speed sensor 60, and subsequently generate and send signals 150, 152, 154 indicative thereof to one or more components within control system 48 for potential subsequent action. Additionally, ECM 50, based off one or more signals (e.g., from ADCM 58, speed sensor 60), is configured to determine and declare: a normal operational state indicated by a signal 156, a rough terrain state indicated by a signal 158, and a fault state indicated by a signal 160.

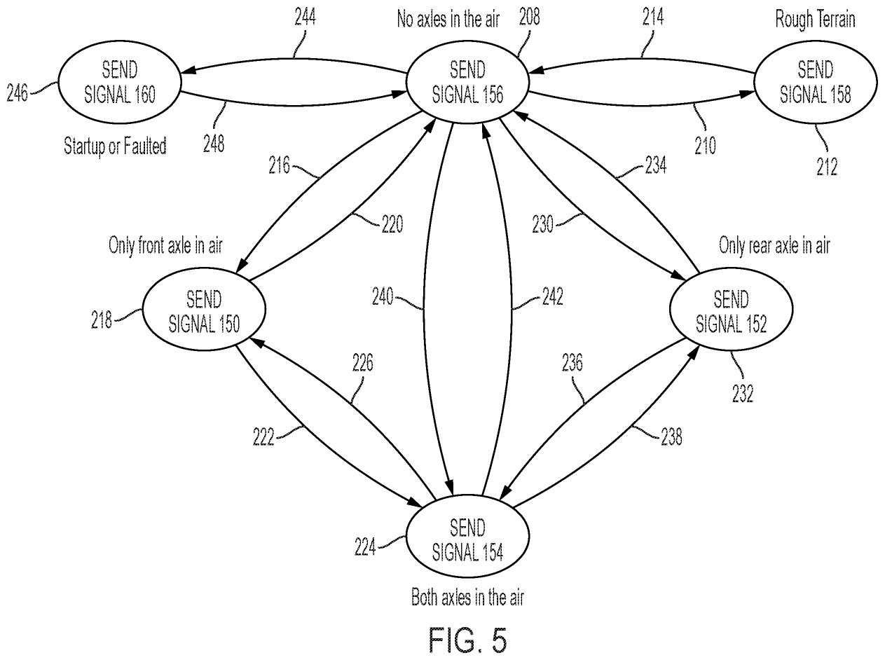

FIG. 5 illustrates a state diagram 200 illustrating which of signals 150, 152, 154, 156, 158, and 160 ECM 50 is configured to send to the one or more components within control system 48. At point 208, ECM 50 determines the vehicle is in the normal operational state and no axles are in the air and sends signal 156 to control system 48. If ECM 50 subsequently determines the vehicle is on rough terrain (line 210), ECM 50 sends signal 158 to control system 48 at point 212. If ECM 50 subsequently determines the vehicle is no longer on rough terrain (line 214), control returns to point 208 and ECM 50 sends signal 156 to control system 48.

If ECM 50 subsequently determines and declares Front Axle Jump Declaration (line 216), control proceeds to point 218 and ECM 50 sends signal 150 indicative thereof to control system 48. At this point, if ECM 50 determines the front axle is no longer airborne (line 220), control returns to point 208. However, if ECM 50 subsequently determines and declares Rear Axle Jump Declaration (line 222), control proceeds to point 224 where ECM 50 declares Both Axles Jump Declaration and sends signal 154 indicative thereof to control system 48. At this point 224, if ECM 50 determines rear axle is no longer airborne (line 226), control returns to point 218 and sends signal 150.

At point 208, if ECM 50 determines and declares the Rear Axle Jump Declaration (line 230), control proceeds to point 232 and ECM 50 sends signal 152 indicative thereof to control system 48. At this point, if ECM 50 determines the rear axle is no longer airborne (line 234), control returns to point 208. However, if ECM 50 subsequently determines and declares the Front Axle Jump Declaration (line 236), control proceeds to point 224 where ECM 50 declares Both Axles Jump Declaration and sends signal 154 indicative thereof to control system 48. At this point 224, if ECM 50 determines front axle is no longer airborne (line 238), control returns to point 232 and sends signal 152.

At point 208, if ECM 50 determines and declares Both Axles Jump Declaration (line 240), control proceeds to point 224 and ECM 50 sends signal 154 indicative thereof to control system 48. At this point, if ECM 50 determines both axles are no longer airborne (line 242), control returns to point 208. If at any of points 208, 214, 218, 224, 232 ECM 50 determines a fault from ADCM 58 or speed sensor 60 (line 244), control proceeds to point 246 where ECM 50 declares a fault and sends signal 160 to control system 48. If ECM 50 subsequently determines there is no fault (line 248), control returns to point 208.

As shown in FIG. 2, in the example embodiment, the ECM 50 is configured to communicate the vehicle's jump status on the vehicle CAN bus for other powertrain modules to utilize. Specifically, the ECM 50 is configured to send signals 150, 152, 154, 156, 158, 160 to PCM 52, TCM 54, and DTCM 56 for automatically implementing powertrain control compensation when a vehicle jump is detected. As described below in more detail, such compensation can include restricting propulsion acceleration and preventing wheel speeds from increasing, and preventing transmission gear shifting, to thereby facilitate reducing or preventing landing shock forces.

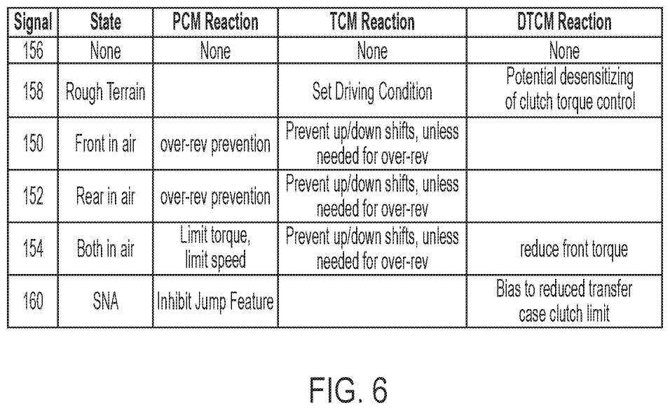

With additional reference to FIGS. 5 and 6, in the example embodiment, the PCM 52 automatically implements powertrain control compensation when it receives signal 150 indicating the front axle is in the air, signal 152 indicating the rear axle is in the air, and signal 154 indicating both axles are in the air. When signal 150 is received, PCM 52 is programmed to perform normal operation. When signal 152 is received, PCM 52 is programmed to perform normal operation. When signal 154 is received, PCM 52 is programmed to perform an engine torque limit to prevent wheel acceleration where a speed of the wheels exceeds a speed of the wheel at the time of jump detection. When signals 156, 158 are received, PCM 52 is programmed to perform normal operations. When fault signal 160 is received, PCM 52 is programmed to inhibit the jump detection feature.

In the example embodiment, the TCM 54 automatically implements powertrain control compensation by modifying the shift schedule to improve driveability, for example, by dampening shift frequency or completely preventing shifting during certain conditions. This can force a direct relationship between engine speed and vehicle speed, and may only shift if critical engine speed limits are reaches (e.g., over-rev limit +200 RPM). In the example implementation, TCM 54 automatically implements powertrain control compensation when it receives signal 150 indicating the front axle is in the air, receives signal 152 indicating the rear axle is in the air, and/or receives signal 154 indicating both axles are in the air. When signal 150, 152, or 154 is received, TCM 54 is programmed to hold the current transmission gear unless needed for over-rev protection. One benefit of this operation of holding the gear when a jump is recognized, is the transmission does not upshift as it normally would under what it could calculate to be low friction condition such as ice, thereby potentially resulting in reduced driveability through a perceived torque sag upon landing. When signals 156, 158 are received, TCM 54 is programmed to perform normal operations or indicate certain predetermined driving conditions exist.

In the example embodiment, the DTCM 56 automatically implements powertrain control compensation to reduce transfer case clutch application to thereby reduce the amount of torque shock input experienced by drivetrain components upon vehicle landing. In the example implementation, DTCM 56 automatically implements powertrain control compensation when it receives signal 154 indicating both axles are in the air. When such signal is received, the DTCM 56 is programmed to limit front axle clutch torque application to facilitate preventing torque spikes through the driveline from landing loads. When signals 150, 152, 156 are received, DTCM 56 is programmed to perform normal operations or indicate certain predetermined driving conditions exist. When signal 158 is received, DTCM 56 can be programmed to perform potential desensitizing of clutch torque control, which is configured to slow down the clutch transitions so the clutch does not swing between applying and reducing torque in an underdamped manner. This reduces clutch thermal generation and prolongs clutch life. When signal 160 is received and certain predetermined conditions are met, DTCM 56 is programmed to bias to a reduced transfer case clutch limit to facilitate preventing damage to components due to reverse torque spike.

Described herein are systems and methods for determining when a front axle, rear axle, or both axles are in the air and subsequently adjusting powertrain control to improve vehicle stability, driveability, and durability. Specifically, the engine control module includes an ECM jump detection feature that independently determines a jump state calibrated for optimum powertrain usage. It utilizes ride height and acceleration sensor data collected by the active damping module (transmitted via CAN bus) and analyzes the data with multiple input signals to meet OBD and torque safety requirements. The ECM then automates a powertrain system response to the various states of a vehicle jump, resulting in improved driveability while enabling lower cost and weight components to be able to withstand harsh vehicle jumping drive cycles.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A vehicle jump detection system for a vehicle having a front axle with front wheels and a rear axle with rear wheels, the system comprising:
an electronic control module (ECM);
at least one ride height sensor (RHS) in signal communication with the ECM and configured to measure a vertical wheel travel distance from a predetermined point on the vehicle;
at least one accelerometer in signal communication with the ECM and configured to measure a vertical acceleration of the vehicle; and
a vehicle speed sensor in signal communication with the ECM;
wherein the ECM is configured to independently determine, based on one or more signals from the at least one RHS, the at least one accelerometer, and the vehicle speed sensor, if (i) the wheels of the front axle are in the air, (ii) the wheels of the rear axle are in the air, and (iii) if the wheels of both the front and rear axles are in the air.

2. The vehicle jump detection system of claim 1, further comprising a powertrain control module (PCM) in signal communication with the ECM; wherein when the ECM determines that (iii) the wheels of both the front and rear axles are in the air, the PCM is configured to limit engine torque to prevent acceleration of wheels of the vehicle to higher than a speed measured at the time ECM determines both the front and rear axles are in the air.

3. The vehicle jump detection system of claim 1, further comprising a transmission control module (TCM) in signal communication with the ECM; wherein when the ECM determines (i) the front axle is in the air, the TCM is configured to hold a current gear of a transmission of the vehicle unless over-rev protection is required.

4. The vehicle jump detection system of claim 3, wherein when the ECM determines (ii) the rear axle is in the air, the TCM is configured to hold a current gear of a transmission of the vehicle unless over-rev protection is required.

5. The vehicle jump detection system of claim 3, wherein when the ECM determines (iii) both the front and rear axles are in the air, the TCM is configured to hold a current gear of a transmission of the vehicle unless over-rev protection is required.

6. The vehicle jump detection system of claim 1, further comprising a drivetrain control module (DTCM) in signal communication with the ECM.

7. The vehicle jump detection system of claim 6, wherein when the ECM determines (iii) both the front and rear axles are in the air, the DTCM is configured to limit front axle clutch torque application to facilitate preventing torque spikes through the driveline induced by landing loads.

8. The vehicle jump detection system of claim 1, wherein the at least one RHS comprises:
a front-right RHS configured to measure a vertical wheel travel distance of a front-right wheel of the vehicle;
a front-left RHS configured to measure a vertical wheel travel distance of a front-left wheel of the vehicle;
a rear-right RHS configured to measure a vertical wheel travel distance of a rear-right wheel of the vehicle; and
a rear-left RHS configured to measure a vertical wheel travel distance of a rear-left wheel of the vehicle,
wherein the one or more signals from the at least one RHS, the at least one accelerometer, and the vehicle speed sensor includes signals indicative of the vertical wheel travel distance measured by the front-right RHS, the front-left RHS, the rear-right RHS, and the rear-left RHS.

9. The jump detection system of claim 1, wherein the at least one accelerometer comprises:
a front-right accelerometer configured to measure a vertical acceleration of a front-right portion of the vehicle;
a front-left accelerometer configured to measure a vertical acceleration of a front-left portion of the vehicle; and
a rear-center accelerometer configured to measure a vertical acceleration of a rear-center portion of the vehicle,
wherein the one or more signals from the at least one RHS, the at least one accelerometer, and the vehicle speed sensor includes signals indicative of the vertical acceleration measured by the front-right accelerometer, the front-left accelerometer, and the rear-center accelerometer.

10. The jump detection system of claim 1, wherein the vehicle speed sensor is configured to measure a speed of the vehicle, wherein the one or more signals from the at least one RHS, the at least one accelerometer, and the vehicle speed sensor includes signals indicative of the measured vehicle speed, and wherein the measured vehicle speed must exceed a predetermined vehicle speed threshold for the ECM to determine (i) the wheels of the front axle are in the air, (ii) the wheels of the rear axle are in the air, and (iii) if the wheels of both the front and rear axles are in the air.

11. The jump detection system of claim 1, further comprising an active damping control module (ADCM) configured to manage stiffness of dampers of the vehicle, wherein the ADCM receives the one or more signals from the at least one RHS and the at least one accelerometer and communicates the one or more signals to the ECM.

12. A method of jump detection and control for a vehicle having a front axle with front wheels, a rear axle with rear wheels, and an electronic control module (ECM) in signal communication with at least one ride height sensor (RHS), at least one accelerometer, and a vehicle speed sensor, the method comprising:
determining with the ECM, based on one or more signals from the at least one RHS, the at least one accelerometer, and the vehicle speed sensor, if (i) the wheels of the front axle are in the air;
determining with the ECM, based on the one or more signals from the at least one RHS, the at least one accelerometer, and the vehicle speed sensor, if (ii) the wheels of the rear axle are in the air;
determining with the ECM, based on the one or more signals from the at least one RHS, the at least one accelerometer, and the vehicle speed sensor, if (iii) the wheels of both the front and rear axles are in the air; and
when (i), (ii), and/or (iii) is determined, sending a signal from the ECM to automatically implement vehicle powertrain control compensation to improve vehicle stability, driveability, and durability.

13. The method of claim 12, wherein automatically implementing vehicle powertrain control compensation comprises (a) restricting propulsion acceleration to prevent wheel speeds from increasing, and (b) preventing gear shifts of a transmission of the vehicle.

14. The method of claim 12, wherein the one or more signals from the at least one RHS, the at least one accelerometer, and the vehicle speed sensor includes a signal indicative of a vertical wheel travel distance measured by the at least one ride height sensor (RHS).

15. The method of claim 12, wherein the one or more signals from the at least one RHS, the at least one accelerometer, and the vehicle speed sensor includes a signal indicative of a measured vertical acceleration measured by the at least one accelerometer.

16. The method of claim 12, wherein the one or more signals from the at least one RHS, the at least one accelerometer, and the vehicle speed sensor includes a signal indicative of a vehicle speed measured by the vehicle speed sensor.
